(19) United States
(12) Patent Application Publication
(10) Pub. No.: US 2015/0161355 A1
(43) Pub. Date: Jun. 11, 2015

(54) System and Methods for Generating a Diet Plan

(71) Applicant: Damodar Karra, Bangalore (IN)

(72) Inventor: Damodar Karra, Bangalore (IN)

(21) Appl. No.: 14/102,606

(22) Filed: Dec. 11, 2013

(51) Int. Cl. G06F 19/00

(52) U.S. Cl. CPC G06F 19/3475

(57) ABSTRACT

Systems and methods for generating preferred diet plans for a patient are presented. Based on diagnoses of the patient, a set of standard diet plans may be retrieved from a plurality of standard diet plans of a diet plan database. Each standard diet plan preferably corresponds to at least one of the diagnoses of the patient. From the set, one of the standard diet plans is selected based on at least one nutritional requirement of the patient. The selected diet plan includes a set of food ingredients from which one or more food ingredients to be replaced are identified. Subsequently, based on a nutritional value of the food ingredient to be replaced, one or more alternate food ingredients are selected. Finally, in the selected diet plan, the alternate food ingredients are substituted for the food ingredient to be replaced.

### FIELD

The present invention relates to diet plan generation techniques and more particularly to methods and systems for generating diet plans for a patient.

### BACKGROUND OF THE EMBODIMENTS

In recent past and in present times, healthcare has become a very important aspect of human society. The healthcare regime has undergone tremendous developments fuelled by path-breaking inventions in diagnostic capabilities, pharmaceutical products, and therapeutic techniques. In addition to providing diagnoses and treatment, healthcare providers and facilities have realized the importance of the emotional well-being of a patient, and thus are investing resources to provide the patient with means to achieve emotional well-being. One factor in achieving an emotional well-being of the patients is the diet/food the patients consume, mainly during their stay in a healthcare facility. This factor of achieving emotional well-being is often ignored by many healthcare providers and has a detrimental effect on the patient. Although, some healthcare providers employ diet professionals, such as dieticians and nutritionists, at their facilities, attention and services of the diet professionals are employed only in cases where strict dietary requirements are needed to help the patient. The services and attention of the diet professionals are not extended to those patients who are not in need of strict dietary requirements.

Furthermore, even for the patients who are under care of the diet professionals, the dietary recommendations are generated manually by these professionals. This leads to several disadvantages, some of which are mentioned herein. First, the generated dietary recommendations or diet plans rely heavily on the skill and knowledge of these professionals, and thus are prone to errors. Moreover, the diet professionals may miss or ignore one or more aspects in creating the diet plans and thus the generated diet plans may not be optimal to the patient's health and likings. Second, generating the diet plans is a time consuming process and thus the services of the diet professionals can only be provided to a select few patients due to the time and resource constraints. Moreover, being a time consuming process, generating diet plans, using the diet professionals, very frequently in a repeated manner for a given patient is troublesome. Furthermore, the process of generating diet plans through the diet professionals results in increasing the overall costs of the healthcare services availed by the patient.

As a result of the above mentioned disadvantages and problems, the emotional well-being of the patients is not achieved and this affects the overall well-being and recovery of the patient.

In addition to aiding achievement of the emotional well-being, a proper dietary recommendation or diet plan is also instrumental in aiding recovery of patients suffering from certain ailments such as diabetes, dyslipidaemia, hypertension, and so on. A proper diet is often used as an important therapeutic means in curing these ailments.

Therefore, it is desirable to develop a technique for generating diet plans for the patients in a simple, expeditious, cost effective way that requires minimal human intervention and input.

### SUMMARY OF THE EMBODIMENTS

An object of the invention is to develop a simple, expeditious, cost effective technique for generating a preferred diet plan for a patient based on a diagnoses of the patient.

Another object of the invention is to develop a technique for generating a preferred diet plan for a patient which requires minimal manual interventions and obviates high reliance on a diet professional's skill and knowledge.

Yet another object of the invention is to develop a technique for generating a preferred diet plan for a patient that aids healthcare facilitates to generate preferred diet plans for their patients free from the resource and time constraints of a diet professional.

The aforementioned objects are achieved with a computerized method for generating a preferred diet plan for a patient, a non-transitory computer-readable storage medium that stores instructions to perform a method for generating a preferred diet plan for a patient, and a system for generating a preferred diet plan for a patient, of the present technique.

According to a first aspect of the present technique, a computerized method for generating a preferred diet plan for a patient diagnosed with diagnoses out of a plurality of diagnoses is presented. In the method, patient specific information is received. The patient specific information includes at least diagnoses information corresponding to the diagnoses of the patient. Subsequently, a set of standard diet plans is retrieved from a plurality of standard diet plans stored in a diet plan database. Each standard diet plan of the plurality corresponds to one or more diagnoses of the plurality of diagnoses. Each standard diet plan of the set of standard diet plans retrieved corresponds to the diagnoses of the patient. From the set of standard diet plans, one of the standard diet plans is selected based on a nutritional requirement of the patient. The selected diet plan includes a set of food ingredients from which one or more food ingredients to be replaced are identified. Subsequently, an ingredient nutritional information database is accessed and from the ingredient nutritional information database one or more alternate food ingredients are selected. A nutritional value of the one or more alternate food ingredients corresponds to a nutritional value of the one or more food ingredients to be replaced. Finally, in the selected diet plan the one or more alternate food ingredients are substituted for the one or more food ingredients to be replaced to generate the preferred diet plan for the patient. In other embodiments, the ingredient may simply be removed and not replaced with another ingredient. In yet another embodiment, one ingredient is replaced by multiple ingredients.

According to a second aspect of the present technique, a non-transitory computer-readable storage medium that stores instructions which, when executed by one or more processor units, cause the one or more processing units to perform a method for generating a preferred diet plan for a patient diagnosed with a diagnoses of a plurality of diagnoses is presented. In the method, patient specific information is received. The patient specific information includes at least diagnoses information corresponding to the diagnoses of the patient. Subsequently, a set of standard diet plans is retrieved from a plurality of standard diet plans stored in a diet plan database. Each standard diet plan of the plurality corresponds to one or more diagnoses of the plurality of diagnoses. Each standard diet plan of the set of standard diet plans retrieved corresponds to the diagnoses of the patient. From the set of standard diet plans, one of the standard diet plans is selected based on a nutritional requirement of the patient. The selected diet plan includes a set of food ingredients from which one or more food ingredients to be replaced are identified. Subsequently, an ingredient nutritional information database is accessed and from the ingredient nutritional information database one or more alternate food ingredients are selected. A nutritional value of the one or more alternate food ingredients corresponds to a nutritional value of the one or more food ingredients to be replaced. Finally, in the selected diet plan the one or more alternate food ingredients are substituted for the one or more food ingredients to be replaced to generate the preferred diet plan for the patient.

According to a third aspect of the present technique, a system for generating a preferred diet plan for a patient diagnosed with a diagnoses of a plurality of diagnoses is presented. The system includes a memory and at least one processing unit. The memory is operable to store at least one program. The at least one processing unit is communicatively coupled to the memory, in which the at least one program, when executed by the at least one processing unit, causes the at least one processing unit to perform the following actions: to receive a patient specific information including at least diagnoses information corresponding to the diagnoses of the patient; to retrieve a set of standard diet plans from a plurality of standard diet plans stored in a diet plan database, wherein each standard diet plan of the plurality corresponds to one or more diagnoses of the plurality of diagnoses and wherein each standard diet plan of the set of standard diet plans to be retrieved by the processing unit corresponds to the diagnoses of the patient; to select one of the standard diet plans from the set of standard diet plans based on a nutritional requirement of the patient, wherein the selected diet plan comprises a set of food ingredients; to identify in the selected diet plan one or more food ingredients to be replaced; to access an ingredient nutritional information database to select one or more alternate food ingredients; to select the one or more alternate food ingredients from the ingredient nutritional information database, wherein a nutritional value of the one or more alternate food ingredients corresponds to a nutritional value of the one or more food ingredients to be replaced from the selected diet plan; and to substitute in the selected diet plan the one or more alternate food ingredients for the one or more food ingredients to be replaced to generate the preferred diet plan for the patient.

The present technique has several advantages. The present technique results in minimization of human intervention, and thus reducing manual errors and reliance on skill and knowledge of a diet professional. Moreover, the technique results in expeditious generation of the diet plans for the patient so it is available to cater to a high number of patients and is usable frequently, thereby reducing the limitation of time constraints and inadequacy in quantities of resources such as the diet professionals. Moreover the present technique is economical, being a simple technique implementable by a computerized method or a system.

### BRIEF DESCRIPTION OF THE DRAWINGS

A full and enabling disclosure of the present technique, including the best mode thereof, directed to one of ordinary skill in the art, is set forth more particularly in the remainder of the specification, which makes reference to the appended figures in which:

FIG. 1 is a schematic representation of an exemplary embodiment of a system for generating a preferred diet plan for a patient, in accordance with aspects of the present technique;

FIG. 2 is a flow diagram depicting an exemplary embodiment of a computerized method for generating a preferred diet plan for a patient, in accordance with aspects of the present technique;

FIG. 3 is a flow diagram depicting a workflow of the exemplary embodiment of the computerized method, in accordance with aspects of the present technique;

FIG. 4 is a schematic representation depicting an exemplary set of standard diet plans with detail of food ingredients or items in each of the standard diet plans of the set, in accordance with aspects of the present technique;

FIG. 5 is a schematic representation depicting an exemplary selected diet plan with detail of food ingredients or items in the selected diet plan, in accordance with aspects of the present technique;

FIG. 6 is a schematic representation depicting an example of a nutritional value in tabulated form for one or more food ingredients to be replaced from the selected diet plan, in accordance with aspects of the present technique;

FIG. 7 is a schematic representation depicting an example of a nutritional value in tabulated form for one or more alternate food ingredients, in accordance with aspects of the present technique; and

FIG. 8 is a schematic representation of an exemplary preferred diet plan, in accordance with aspects of the present technique.

Repeat use of reference characters in the present specification and drawings is intended to represent same or analogous features or elements of the technique.

### DETAILED DESCRIPTION OF THE EMBODIMENTS

Reference now will be made in detail to various embodiments of the technique, one or more examples of which are set forth below. Each example is provided by way of explanation of the technique, not limitation of the technique. Various modifications and variations, as may be perceived by a person skilled in the art, may be made in the present technique without departing from the scope or spirit of the technique. Features illustrated or described as part of one embodiment, may be used on another embodiment. Thus, it is intended that the present technique covers such modifications and variations as come within the scope of the appended claims and their equivalents.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

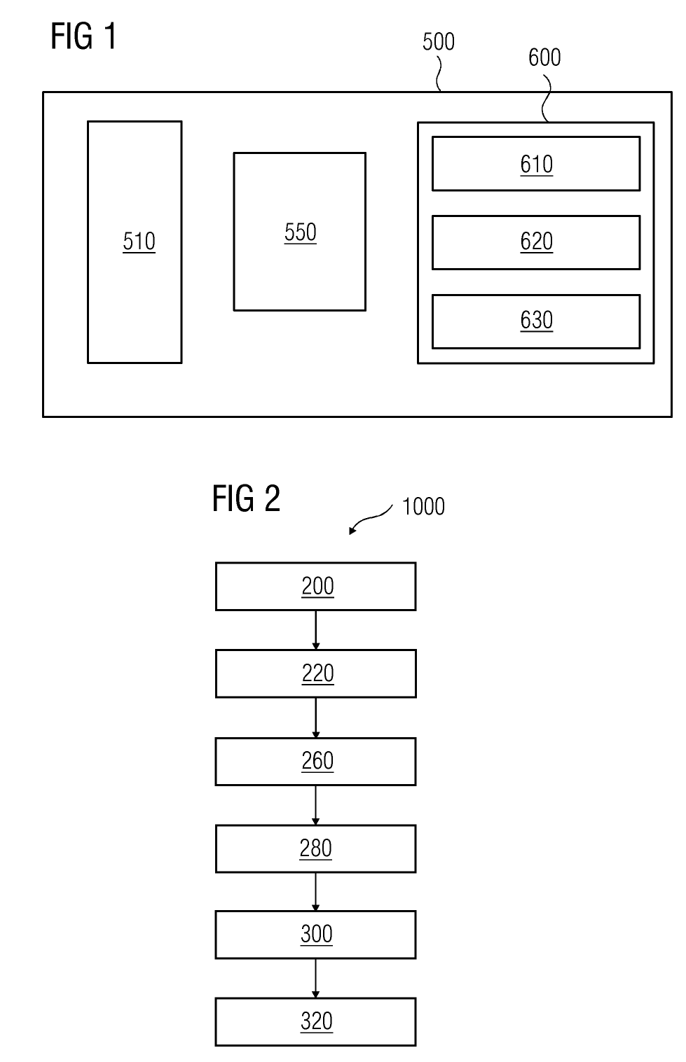

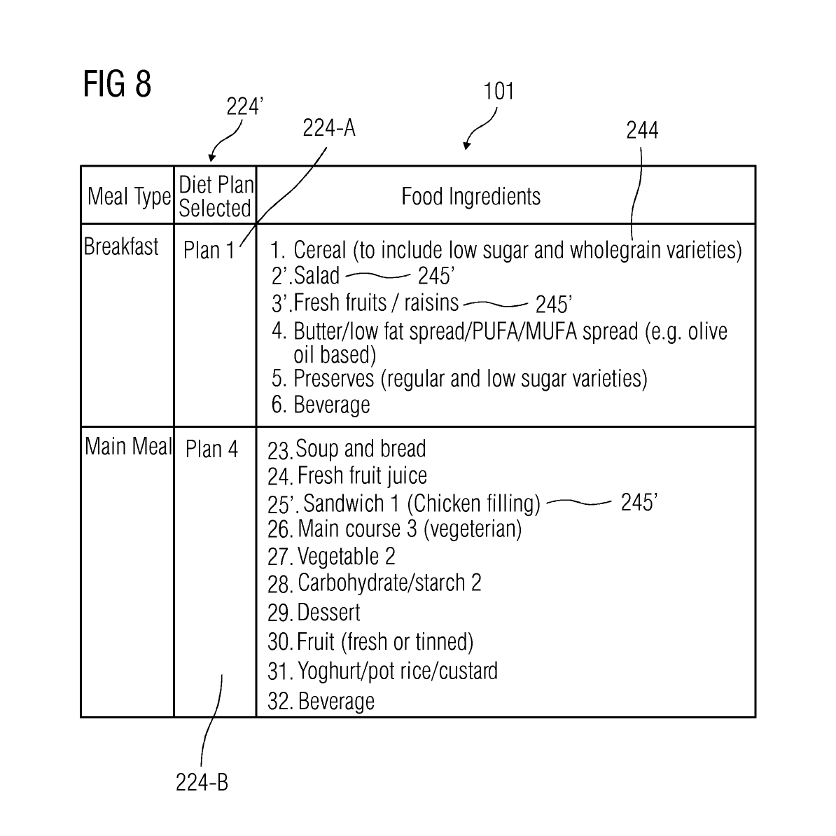

FIG. 1 is a schematic representation of an exemplary embodiment of a system 500 for generating a preferred diet plan 101, as depicted in FIG. 8 which schematically represents exemplary preferred diet plan 101 for a patient diagnosed with a diagnoses out of a plurality of diagnoses.

The ‘diet plan’, as used herein, refers to a collection of one or more food items or food ingredients to be served to an individual for a meal, such as breakfast, lunch, dinner, etc. The term ‘food ingredients’, as used herein includes food items for example, bread, sandwich, etc., and/or ingredients from which a food item is made for example, flour with which a bread is made, added sugar and fruit extract from which a fruit juice is made, and so on and so forth. The term ‘preferred diet plan for a patient’, as used herein, refers to a diet plan for a patient customized for the patient. The customization may be performed in various ways. For example, one way of customization is by identifying, in the diet plan, at least one food ingredient to which the patient is allergic and substituting in the diet plan, the food ingredients to which the patient is allergic with at least one food ingredient to which the patient is non-allergic. Another way of customization is by identifying, in the diet plan, at least one food ingredient which is disliked or undesired by the patient and substituting in the diet plan, the food ingredients which is disliked or undesired by the patient with at least one food ingredient which is liked or desired by the patient. Yet another way of customization is by identifying, in the diet plan, at least one food ingredient which is rejected for the patient by a healthcare consultant and substituting in the diet plan, the food ingredients which is rejected for the patient by the healthcare consultant with at least one food ingredient which is recommended for the patient by the healthcare consultant. The healthcare consultant may be, but not limited to, a dietician, a nutritionist, a physician, a nurse, and so on. A ‘patient’ may be any person who has been or will be diagnosed or partially diagnosed with a medical condition or conditions.

The term ‘diagnoses’, as used herein, means a health condition in which a person suffers from a physical or mental disorder such a disease and/or an injury and/or an abnormality. Examples of diagnoses, also referred to as diagnostic conditions, may be, but not limited to, diabetes, head injury, burns, malnutrition, acute kidney failure with chronic kidney disease, dyslipidaemia, hypertension, acute obesity, and so on and so forth. The plurality of diagnoses includes different diagnoses. As used herein, a patient is said to be diagnosed with a diagnoses when it is identified or determined that the patient is in a health condition that has been ascertained to be a particular diagnoses.

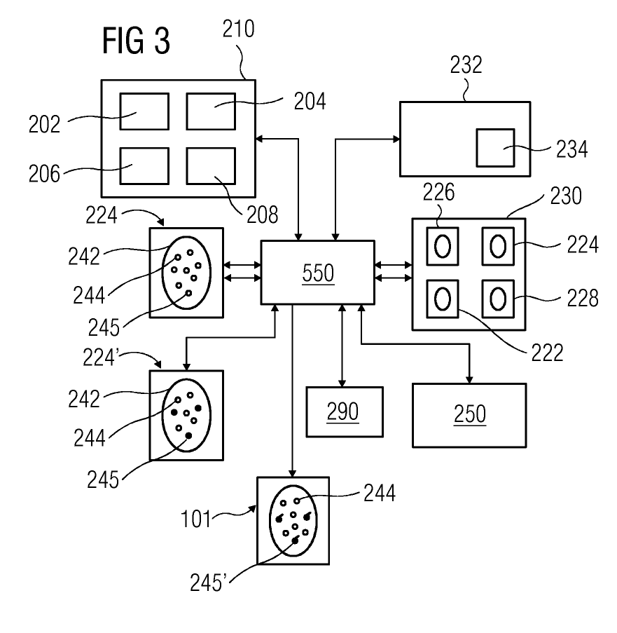

The system 500 includes a memory 510 and at least one processing unit 550. The memory 510 is operable to store at least one program. The at least one processing unit 550 is communicatively coupled to the memory 510. When the program is in the memory 510 and is executed by the processing unit 550, the program causes the processing unit 550 to perform the following actions: to receive a patient specific information including at least a diagnoses information corresponding to the diagnoses of the patient; to retrieve a set of standard diet plans from a plurality of standard diet plans stored in a diet plan database, wherein each standard diet plan of the plurality correspond to one or more diagnoses of the plurality of diagnoses and wherein each standard diet plan of the set of standard diet plans to be retrieved by the processing unit corresponds to the diagnoses of the patient; to select one of the standard diet plans from the set of standard diet plans based on a nutritional requirement of the patient, wherein the selected diet plan comprises a set of food ingredients; to identify in the selected diet plan one or more food ingredient to be replaced; to access an ingredient nutritional information database to select one or more alternate food ingredients; to select the one or more alternate food ingredients from the ingredient nutritional information database, wherein a nutritional value of the one or more alternate food ingredients corresponds to a nutritional value of the one or more food ingredient to be replaced from the selected diet plan; and to substitute in the selected diet plan the one or more alternate food ingredients for the one or more food ingredients to be replaced to generate the preferred diet plan 101 for the patient. The system 500 and the actions to be performed by the processing unit 550 are explained further in detail in conjunction with explanation of FIG. 2 and FIG. 3.

FIG. 2 is a flow diagram depicting an exemplary embodiment of a computerized method 1000 for generating the preferred diet plan 101 for the patient diagnosed with the diagnoses out of the plurality of diagnoses. The method 1000 has been explained hereinafter in combination with FIG. 3 which represents a flow diagram depicting a logical workflow of the computerized method 1000.

In the computerized method 1000, patient specific information 210 is received in a step 200. The patient specific information 210 includes at least diagnoses information 202 corresponding to the diagnoses of the patient. The diagnoses information 202 is data that is identifiable with the diagnoses of the patient, for example, the diagnoses information 202 may be, but not limited to, name of the diagnoses such as name of a disease like ‘Diabetes mellitus’ or a unique code assigned to a diagnoses such as say an exemplary code ‘E08’ for Diabetes mellitus Type 1, an exemplary code ‘E09’ for Diabetes mellitus Type 2, an exemplary code ‘T20’ for first degree burn, an exemplary code ‘T22’ for a second degree burn, an exemplary code ‘DL7’ for Dyslipidaemia, an exemplary code ‘HN1’ for Hypertension etc. The diagnoses information 202 is received by a processor of a computer system for example the processing unit 550 of the system 500.

In an embodiment of the present technique, before initiation of the method 1000, the patient specific information 210 is present or stored in a clinical IT infrastructure (not shown) and databases (not shown), such as, but not limited to, electronic patient records (EPR), health information exchanges (HIE), hospital information systems (HIS) and/or clinical workflow management systems. Example of electronic patient records (EPR), hospital information systems (HIS) and/or clinical workflow management systems which may be products like “SOARIAN®” or “SYNGO®”, as readily available and prevalently used, from Siemens®. In one embodiment of the method 1000, the patient specific information 210 is received in the step 200 by the processing unit 550 of the system 500 from the clinical IT infrastructure and databases.

Subsequently, in a step 220 a set 230 of standard diet plans 222,224,226,228 is retrieved. The set 230 is retrieved from a diet plan database 232. The diet plan database 232 includes a plurality 234 of standard diet plans meaning thereby that the plurality 234 includes at least all the standard diet plans 222,224,226,228 retrieved as the set 230 and optionally more standard diet plans (not shown). Each standard diet plan, i.e. all the standard diet plans 222,224,226,228 and optionally more standard diet plans (not shown) of the plurality 234 correspond to one or more diagnoses of the plurality of diagnoses. One such exemplary diet plan database 232 in which the plurality 234 is present is depicted in Table 1. It may be noted that the database 232 and the plurality 234 may be structured in completely different scheme or pattern than depicted in Table 1. It may further be noted that Table 1 is not exhaustive and is shown as an example for purpose of explanation.

TABLE 1

| | | | Column 3 |
|---|---|---|---|
| Diet Plan | Column 1 | Column 2 | Code for the |
| Database | Standard Diet Plans | Diagnoses | Diagnoses |
| Row 1 | Plan 001 | Diabetes Type 1 | E08 |
| Row 2 | Plan 002 | Dyslipidaemia | DL7 |
| Row 3 | Plan 023 | Hypertension | HN1 |
| Row 4 | Plan 222 | Diabetes Type 1; | E08; E09; HN1 |
| | | Diabetes Type 2; | |
| | | Hypertension | |
| Row 5 | Plan 223 | Burn 1^{st} Degree | T20 |
| Row 6 | Plan 224 | Diabetes Type 1 | E08 |
| Row 7 | Plan 225 | Burn 1^{st} Degree | T20 |
| Row 8 | Plan 226 | Diabetes Type 1 | E08 |
| Row 9 | Plan 228 | Diabetes Type 1 | E08 |
| Row 10 | Plan 421 | Dyslipidaemia | DL7 |
| Row 11 | Plan A21 | Hypertension | HN1 |
| Row 12 | Plan B21 | Dyslipidaemia | DL7 |
| Row 13 | Plan B29 | Dyslipidaemia | DL7 |
| Row 14 | Plan N11 | Hypertension | HN1 |

In Table 1, column 1 shows the plurality 234 including the various standard diet plans, namely ‘Plan 001’ in row 1 to ‘Plan N11’ in row 14 of Table 1. Column 2 shows the plurality of diagnoses and column 3 shows the corresponding codes for the different diagnoses. As depicted in Table 1, in accordance with aspects of the present technique, each standard diet plan, i.e. ‘Plan 001’ to ‘Plan N11’ of the plurality 234 corresponds to one or more diagnoses of the plurality of diagnoses. For example in Table 1, the standard diet plan ‘Plan 001’ corresponds to the diagnoses ‘Diabetes Type 1’ and/or the code ‘E08’ for diabetes type 1, the standard diet plan ‘Plan 002’ corresponds to the diagnoses ‘Dyslipidaemia’ and/or the code ‘DL7’ for dyslipidaemia, the standard diet plan ‘Plan 023’ corresponds to the diagnoses ‘Hypertension’ and/or the code ‘HN1’ for hypertension, the standard diet plan ‘Plan 222’ corresponds to more than one of the diagnoses namely, ‘Diabetes Type 1’ and/or ‘E08’, ‘Diabetes Type 2’ and/or ‘E09’ and ‘Hypertension’ and/or ‘HN1’, and so on and so forth.

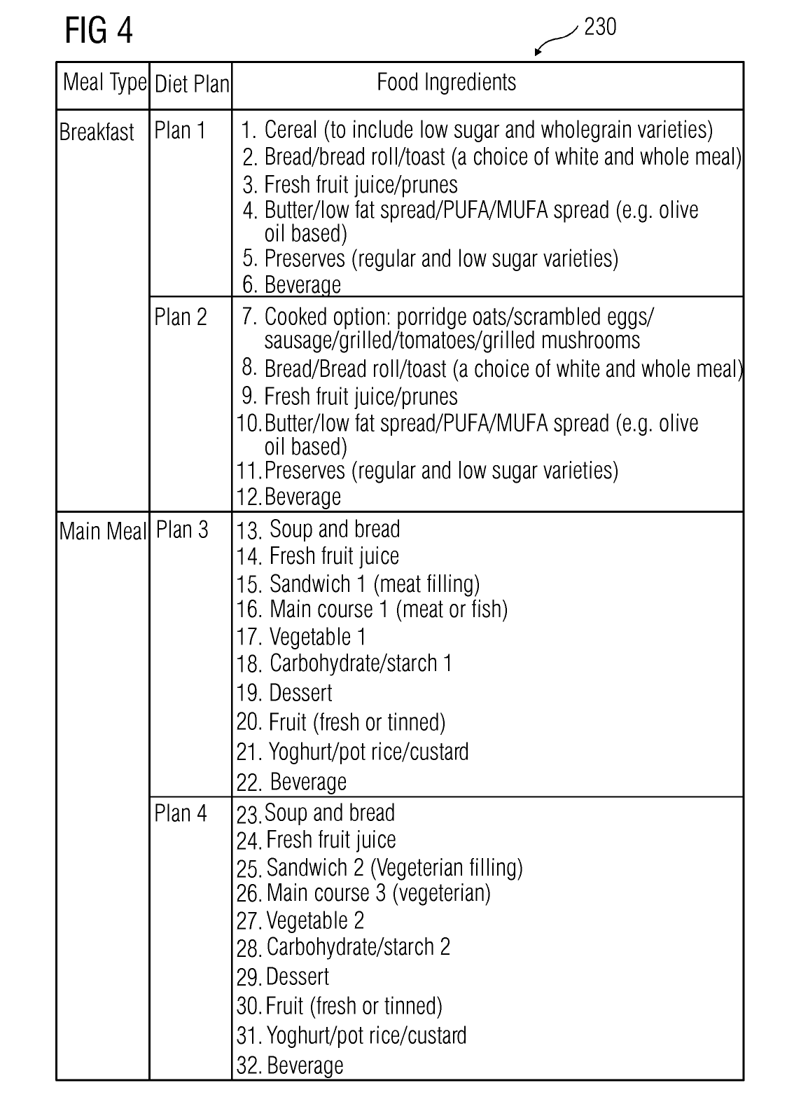

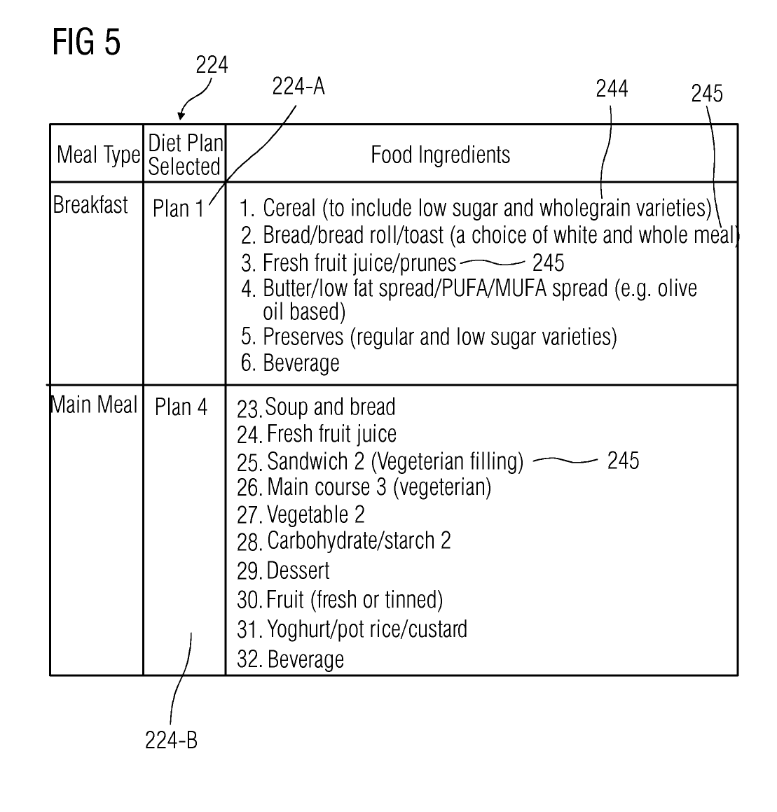

In the step 220, when the set 230 is retrieved from the diet plan database 232, each standard diet plan 222,224,226,228 of the set 230 retrieved corresponds to the diagnoses of the patient. For example, say the patient is diagnosed with Diabetes Type 1 disease, then the diagnoses information 202 received in step 200 will indicate that the patient suffers from Diabetes Type 1 disease, and then in step 220 those standard diet plans will be retrieved in form of set 230 from the diet plan database 232 which correspond to diabetes type 1, which in example of Table 1 will be Plan ‘222’, ‘Plan 224’, ‘Plan 226’ and Plan ‘228’. FIG. 4 is a schematic representation depicting another example of set 230 of standard diet plans with detail of food ingredients or items in each of the standard diet plans of the set 230.

The step 220 may be performed by a processor such as the processing unit 550 of the system 500. The diet plan database 232 may be locally stored in a server (not shown) of a healthcare facility (not shown) and directly communicate in a wired or wireless communication with the processing unit 550 or may be stored at some remote location as compared to the healthcare facility and may communicate with the processing unit 550 through a communication protocol such as communicating through the internet in a wired or wireless configuration.

Further in method 1000, in a step 240, one of the standard diet plans 222,224,226,228 is selected from the set 230. The selection in the step 240 is performed based on a nutritional requirement of the patient. The term ‘nutritional requirement’, as used herein, is an indicator or information about nutrition needed for the patient and may include, but not limited to, daily calorific requirement for the patient and/or amounts of each nutrient needed for the patient in a given time interval such as for each meal or for each day. The nutritional requirements for different patients vary between individuals based on at least one of the individual's age, gender, weight, body mass index, height, level of physical activity, state of health such as diagnosed condition, and life stages, e.g. women of childbearing age need more iron than men.

In one embodiment of the present technique, the patient specific information 210 may include the nutritional requirement of the patient and may be received in the step 200 along with the patient diagnoses information 202. In another embodiment, the patient specific information 210 includes biographical information of the patient and the nutritional requirement of the patient is determined based on the biographical information of the patient. The ‘biographical information’, as used herein, means information relating to facts or events of the patient such as, but not limited to, age of the patient, gender of the patient, body weight of the patient, height of the patient, and so on and so forth. The biographical information is used to determine nutritional requirement of the patient from a reference nutritional requirement database 250 as depicted schematically in FIG. 3.

The reference nutritional requirement database 250 is a collection of data that includes a plurality of nutritional requirements for different persons classified at least according to one of genders of the different persons, ages of the different persons, body weights of the different persons, diagnoses of the different persons, or a combination thereof. Table 2 depicts an exemplary reference nutritional requirement database 250 based on age and gender of an individual and showing nutritional requirement in form of calorific requirements for the individual. It may be noted that the reference nutritional requirement database 250 may be structured in completely different scheme or pattern than depicted in Table 2. It may further be noted that Table 2 is not exhaustive and is shown as an example for purpose of explanation.

TABLE 2
Reference Nutritional Requirement Database

| | |
|---|---|
| | Nutritional requirement |
| | Daily Calorific requirement |
| Age | (kilo-calorie/day) |

| (years) | Male | Female |
|---|---|---|
| 0.8-0.9 | 920 | 865 |
| 1-3 | 1230 | 1165 |
| 4-6 | 1715 | 1545 |
| 7-10 | 1970 | 1740 |
| 11-14 | 2220 | 1845 |
| 15-18 | 2755 | 2110 |
| 19-49 | 2550 | 1940 |
| 50-59 | 2550 | 1900 |
| 60-64 | 2380 | 1900 |
| 65-74 | 2330 | 1900 |
| 75+ | 2100 | 1810 |

The reference nutritional requirement database 250, may further include, but not limited to, similar data relating to nutritional requirements of daily protein intake, daily mineral intake, daily vitamin intake, and so on and so forth.

Thus, by using the biographical information of the patient in conjunction with the reference nutritional requirement database 250, the nutritional requirement for the patient is determined.

In the step 240, that standard diet plan from the set 230 of standard diet plans 222,224,226,228 is selected which best fulfils and/or substantially matches or is the closest match for the nutritional requirement for the patient, obtained from the patient specific information 210 and/or determined from the biographical information of the patient. Say in the example of Table 1, the selected diet plan is ‘Plan 224’ in row 6 column 1 of Table 1. In FIG. 3, the selected diet plan is represented by reference numeral ‘224’. The selected diet plan 224 includes a set 242 of food ingredients 244,245, as depicted schematically in FIG. 3. FIG. 5 is a schematic representation depicting another example of the selected diet plans 224 with detail of food ingredients 244,245 or items in the selected diet plan 224. The selected diet plan 224 may further include separate parts 224-A, 224-B classified according to periods of a day for which the selected diet plan 224 is applicable. The step 240 may be performed by a processor such as the processing unit 550 of the system 500.

Referring to FIG. 2 and FIG. 3, further in the method 1000, in a step 260, from the set 242 of food ingredients 244,245, one or more food ingredient 245 to be replaced are identified. The step 260 may be performed by a processor such as the processing unit 550 of the system 500. In FIG. 3, reference numeral ‘224′’ schematically represents the selected diet plan 224 in which the one or more food ingredients 245 to be replaced have been identified.

In one embodiment of the method 1000, the identification, in the step 260, of the food ingredient 245 to be replaced in the selected diet plan 224 is performed based on food ingredients allergy information 204 for the patient. In this embodiment, the patient specific information 210 includes the food ingredients allergy information 204 for the patient. The food ingredients allergy information 204 includes information or data indicating a particular food ingredient allergic for the patient and/or a particular food ingredient non-allergic for the patient. Thus, in the set 242, one or more of those food ingredients are selected for which the patient is allergic for example the food ingredient 245.

In another embodiment of the method 1000, the identification, in the step 260, of the food ingredient 245 to be replaced in the selected diet plan 224 is performed based on food desirability information 206 for the patient. In this embodiment, the patient specific information 210 includes the food desirability information 206 for the patient. The food desirability information 206 includes information or data indicating a particular food ingredient desirable or liked by the patient and/or a particular food ingredient undesirable or disliked by the patient. Thus, in the set 242, one or more of those food ingredients are selected which are undesirable or disliked by the patient for example the food ingredient 245.

In yet another embodiment of the method 1000, the identification, in the step 260, of the food ingredient 245 to be replaced in the selected diet plan 224 is performed based on healthcare consultant recommendation 208 for the patient. In this embodiment, the patient specific information 210 includes the healthcare consultant recommendation 208 for the patient. The healthcare consultant recommendation 208 includes information or data indicating a particular food ingredient recommended for the patient by a healthcare consultant and/or a particular food ingredient rejected for the patient by the healthcare consultant. Thus, in the set 242, one or more of those food ingredients are selected which are rejected for the patient by the healthcare consultant for example the food ingredient 245.

In the method 1000, subsequent to step 260, an ingredient nutritional information database 290, depicted in FIG. 3, is accessed in a step 280 as depicted in FIG. 2. The ingredient nutritional information database 290 includes a plurality of food ingredients. Each food ingredient of the plurality is assigned a nutritional value including a calorific value of the food ingredient and/or a protein content of the food ingredient and/or a carbohydrate content of the food ingredient and/or a fat content of the food ingredient and/or a mineral content of the food ingredient and/or a vitamin content of the food ingredient and/or a sugar content of the food ingredient and/or a salt content of the food ingredient. An exemplary embodiment of the ingredient nutritional information database 290 is depicted in Table 3. It may be noted that the ingredient nutritional information database 290 may be structured in completely different scheme or pattern than depicted in Table 3. It may further be noted that Table 3 is not exhaustive and is shown as an example for purpose of explanation.

TABLE 3
Ingredient Nutritional Information Database

| | | Nutritional Value of Food ingredients per 100 gram | | | | | |
|---|---|---|---|---|---|---|---|
| | Food | | Pro- | | | | |
| | ingre- | Energy | teins | Carbohy- | Fat | Calcium | Iron |
| Category | dient | (Kcal) | (g) | drates (g) | (g) | (mg) | (mg) |
| Milk & | Milk | 67 | 3.2 | 4.4 | 4.1 | 120 | 0.2 |
| Milk | Curd | 60 | 3.1 | 3.0 | 4.0 | 149 | 0.2 |
| products | Cheese | 348 | 24.1 | 6.3 | 25.1 | 790 | 2.1 |
| Fruits | Apple | 59 | 0.2 | 13.4 | 0.5 | 10 | 0.66 |
| | Banana | 116 | 1.2 | 27.2 | 0.3 | 17 | 0.36 |
| | Apricot | 53 | 1.0 | 11.6 | 0.3 | 20 | 2.2 |
| Fats | Butter | 729 | 0 | 0 | 81 | 0 | 0 |
| & oils | Palm oil | 900 | 0 | 0 | 100 | 0 | 0 |

Furthermore in the method 1000, in a step 300, using the ingredient nutritional information database 290, one or more alternate food ingredient is selected. Subsequently, in a step 320, in the selected diet plan 224, 224′, the one or more alternate food ingredients are substituted for the one or more food ingredient 245 to be replaced to generate the preferred diet plan 101 for the patient. A nutritional value of the one or more alternate food ingredients selected from the ingredient nutritional information database 290 corresponds to a nutritional value of the one or more food ingredient 245 to be replaced. This has been explained further in combination with FIGS. 5 to 8.

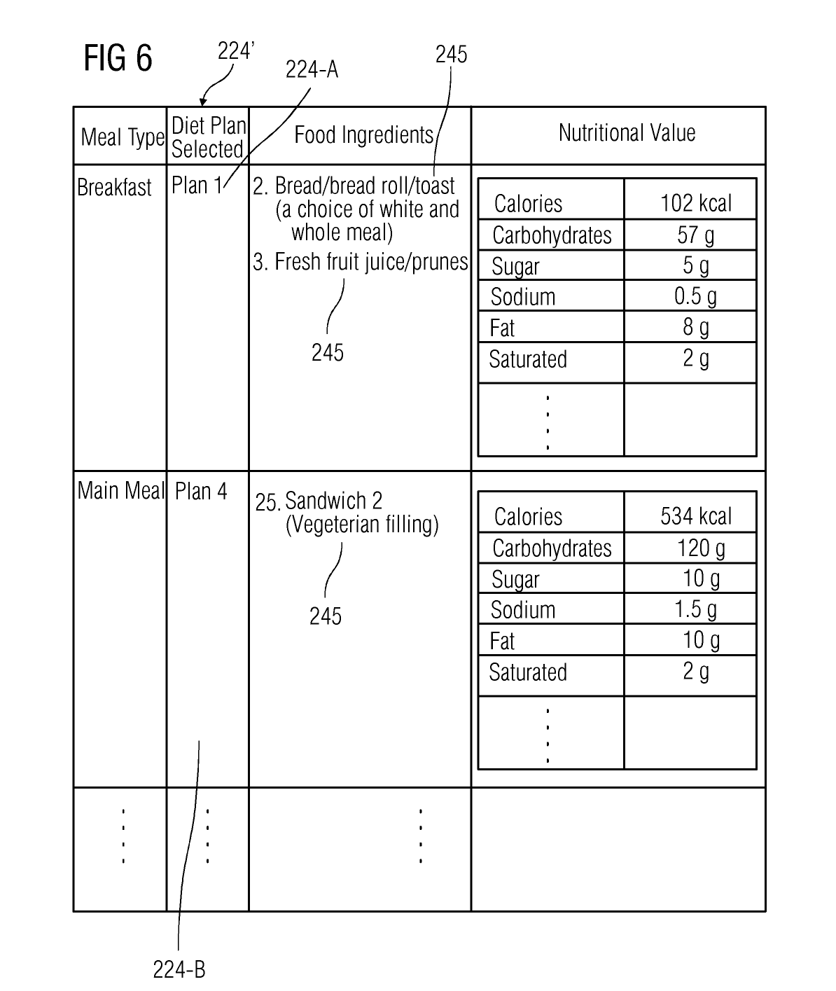

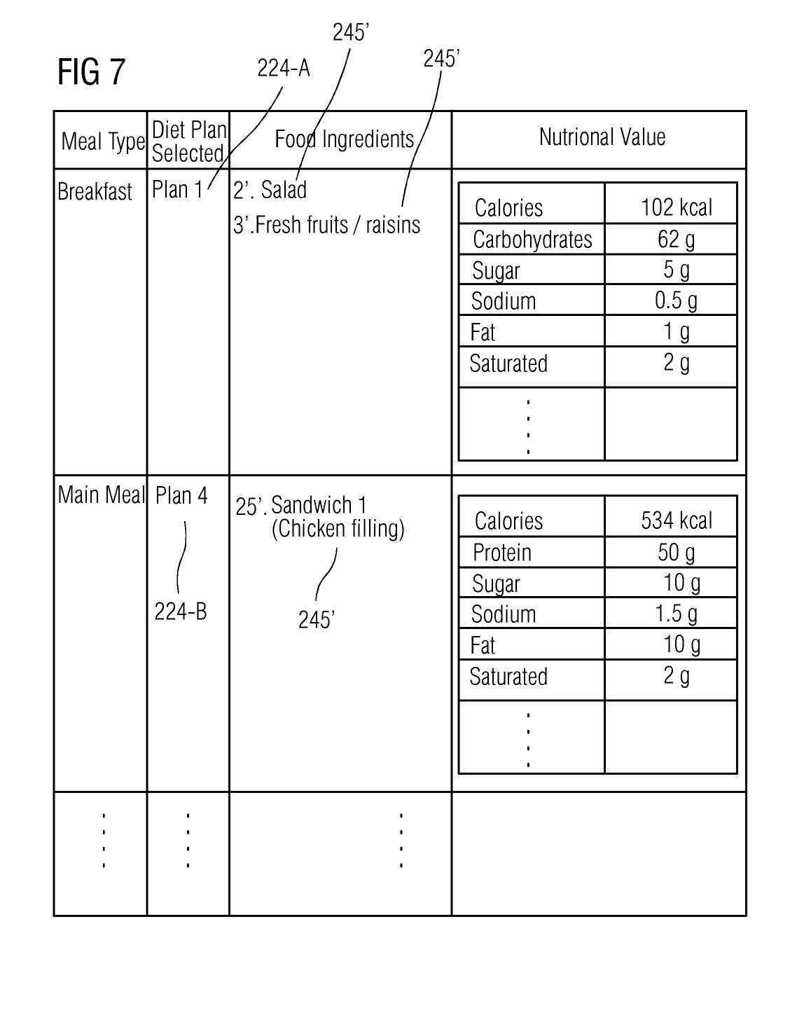

FIG. 6 is a schematic representation depicting exemplary nutritional values in tabulated form for one or more food ingredients 245 to be replaced from the selected diet plan 224, particularly from the parts 224-A and 224-B of the selected diet plan 224. As seen in FIG. 6, say from part 224-A of FIG. 5, food ingredients 245 to be replaced depicted by entry numbers ‘2’ and ‘3’ of FIG. 5 are selected, and similarly, say from part 224-B of FIG. 5, food ingredients 245 to be replaced depicted by entry number ‘25’ of FIG. 5 is selected and accordingly depicted in FIG. 6; in accordance with aspects of the present technique. FIG. 7 is a schematic representation depicting exemplary nutritional values in tabulated form for one or more alternate food ingredients 245′ to be substituted for the one or more food ingredients 245 to be replaced of the selected diet plan 224, particularly from the parts 224-A and 224-B of the selected diet plan 224. As seen in FIG. 7, say, to replace the food ingredients 245 depicted by entry numbers ‘2’ and ‘3’ of FIG. 6, the alternate food ingredient 245′ depicted by entry numbers ‘2′’ and ‘3′’ of FIG. 7 are selected, and say, to replace the food ingredients 245 depicted by entry number ‘25’ of FIG. 6, the alternate food ingredient 245′ depicted by entry number ‘25′’ of FIG. 7 is selected, in accordance with aspects of the present technique. It may be noted, that by a comparison of FIG. 6 and FIG. 7, it can be observed that the nutritional value of the alternate food ingredients 245′ corresponds to the nutritional value of the food ingredient 245 to be replaced. Finally, in the step 320, in the selected diet plan 224, 224′, the one or more alternate food ingredients 245′ are inserted and the one or more food ingredient 245 to be replaced are removed leading to the generation of the preferred diet plan 101 for the patient, as depicted in FIG. 3 and FIG. 8.

To explain further, in the method 1000, in the selected diet plan 224,224′, at least one food ingredient 245 to which the patient is allergic is substituted with at least one alternate food ingredient 245′ to which the patient is non-allergic; and/or at least one food ingredient 245 which is undesirable by the patient is substituted with at least one alternate food ingredient 245′ which is desirable by the patient; and/or at least one food ingredient 245 which is rejected for the patient by the healthcare consultant is substituted with at least one alternate food ingredient 245′ which is recommended for the patient by the healthcare consultant.

It may be noted that, one or more of the steps 280, 300 and 320, may be performed by a processor such as the processing unit 550 of the system 500. It may also be noted, that though for sake of clarity, only one processing unit 550 is shown to perform one or more of the steps of the method 1000, it will be clear to one skilled in the art, that each step of the method 1000 may be performed by different processors or different processing units 550 of the system 500.

Referring to FIG. 1, in one embodiment of the system 500, the system 500 may further include a first data storage module 610. The first data storage module 610 includes at least a part of the diet plan database 232. In another embodiment of the system 500, the system 500 may include a second data storage module 620. The second data storage module 620 includes at least a part of the ingredient nutritional information database 290. In another embodiment of the system 500, the system 500 may include a third data storage module 630. The third data storage module 630 includes at least a part of the reference nutritional requirement database 250. One or more of the data storage modules 610, 620, 630 is any device or part thereof suitable for storing a collection of electronic data in forma of a database, and may be, but not limited to, an external hard disk, a server, a disk, a floppy drive, and so on and so forth. One or more of the data storage modules 610, 620, 630 may be segments of a data storage unit 600.

In accordance with aspects of the present technique, a non-transitory computer-readable storage medium (not shown) that stores instructions which, when executed by one or more processor units, cause the one or more processing units to perform the method 1000 as described in reference to FIGS. 1 to 8 is envisaged. In accordance with aspects of the present technique, any embodiment of the aforementioned method 1000 may be embodied in the form of these instructions also referred to as a computer program. The instructions may be stored on the non-transitory computer-readable media and is adapted to perform any embodiment of the aforementioned method 1000 when run on a processing system such as the system 500 with the processing unit 550.

The non-transitory computer readable storage media that store the program or the instructions (i.e., software modules comprising computer readable instructions) may include volatile and non-volatile, removable and non-removable media implemented in any method or technology for storage of information such as computer-readable instructions, data structures, program modules, or other data. Computer-readable storage media may include, but is not limited to, RAM, ROM, Erasable Programmable ROM (EPROM), Electronically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the processing system and processed.

Although the present technique has been described with reference to specific embodiments, this description is not meant to be construed in a limiting sense. Various modifications of the disclosed embodiments, as well as alternate embodiments of the technique, will become apparent to persons skilled in the art upon reference to the description of the technique. It is therefore contemplated that such modifications can be made without departing from the embodiments of the present technique as defined.

1. A computerized method for generating a preferred diet plan for a patient, the method comprising:
receiving patient specific information including at least diagnoses information related to a diagnoses of the patient;
retrieving a set of standard diet plans from a plurality of standard diet plans stored in a diet plan database, wherein each standard diet plan corresponds to one or more diagnoses of a plurality of diagnoses;
selecting one of the standard diet plans from the set of standard diet plans based on a nutritional requirement of the patient, wherein the selected diet plan comprises a set of food ingredients;
identifying, in the selected diet plan, one or more food ingredients to be replaced;
accessing an ingredient nutritional information database to select one or more alternate food ingredients;
selecting the one or more alternate food ingredients from the ingredient nutritional information database, wherein a nutritional value of the one or more alternate food ingredients corresponds to a nutritional value of the one or more food ingredients to be replaced from the selected diet plan; and
substituting, in the selected diet plan, the one or more alternate food ingredients for the one or more food ingredients to be replaced to generate the preferred diet plan for the patient.

2. The method according to claim 1, wherein the ingredient nutritional information database comprises a plurality of food ingredients and wherein each food ingredient of the plurality is assigned a nutritional value including at least one selected from the group consisting of: a calorific value of the food ingredient, a protein content of the food ingredient, a carbohydrate content of the food ingredient, a fat content of the food ingredient, a mineral content of the food ingredient, a vitamin content of the food ingredient, a sugar content of the food ingredient, a salt content of the food ingredient, and a combination thereof.

3. The method according to claim 1, wherein the patient specific information includes food ingredients allergy information for the patient, the food ingredients allergy information comprising at least one selected from the group consisting of: a food ingredient allergic for the patient, a food ingredient non-allergic for the patient and a combination thereof, and wherein the one or more food ingredients to be replaced in the selected diet plan are identified based on the food ingredients allergy information for the patient.

4. The method according to claim 1, wherein the patient specific information includes food desirability information for the patient, the food desirability information for the patient comprising at least one selected from the group consisting of: a food ingredient desirable by the patient, a food ingredient undesirable by the patient and a combination thereof, and wherein the one or more food ingredients to be replaced in the diet plan are identified based on the food desirability information for the patient.

5. The method according to claim 1, wherein the patient specific information includes healthcare consultant recommendation for the patient, the healthcare consultant recommendation for the patient comprising at least one selected from the group consisting of: a food ingredient recommended for the patient by a healthcare consultant, a food ingredient rejected for the patient by the healthcare consultant and a combination thereof, and wherein the one or more food ingredients to be replaced in the selected diet plan are identified based on the healthcare consultant recommendation information for the patient.

6. The method according to claim 1, wherein patient specific information includes the nutritional requirement of the patient.

7. The method according to claim 1, wherein the patient specific information includes biographical information of the patient and wherein the nutritional requirement of the patient is determined based on the biographical information of the patient from a reference nutritional requirement database, wherein the reference nutritional requirement database includes a plurality of nutritional requirements for different persons classified at least according to one of genders of the different persons, ages of the different persons, body weights of the different persons, diagnoses of the different persons, or a combination thereof.

8. The method according to claim 1, wherein the patient specific information is received from a database of a healthcare provider.

9. A non-transitory computer-readable storage medium that stores instructions which, when executed by one or more processing units, cause the one or more processing units to perform a method for generating a preferred diet plan for a patient, the method comprising:
receiving patient specific information including at least diagnoses information related to a diagnoses of the patient;
retrieving a set of standard diet plans from a plurality of standard diet plans stored in a diet plan database, wherein each standard diet plan corresponds to one or more diagnoses of a plurality of diagnoses;
selecting one of the standard diet plans from the set of standard diet plans based on a nutritional requirement of the patient, wherein the selected diet plan comprises a set of food ingredients;
identifying, in the selected diet plan, one or more food ingredients to be replaced;
accessing an ingredient nutritional information database to select one or more alternate food ingredients;
selecting the one or more alternate food ingredients from the ingredient nutritional information database, wherein a nutritional value of the one or more alternate food ingredients corresponds to a nutritional value of the one or more food ingredients to be replaced from the selected diet plan; and
substituting, in the selected diet plan, the one or more alternate food ingredients for the one or more food ingredients to be replaced to generate the preferred diet plan for the patient.

10. The non-transitory computer-readable storage medium according to claim 9, wherein the ingredient nutritional information database comprises a plurality of food ingredients and wherein each food ingredient of the plurality is assigned a nutritional value including at least one selected from the group consisting of: a calorific value of the food ingredient, a protein content of the food ingredient, a carbohydrate content of the food ingredient, a fat content of the food ingredient, a mineral content of the food ingredient, a vitamin content of the food ingredient, a sugar content of the food ingredient, a salt content of the food ingredient, and a combination thereof.

11. The non-transitory computer-readable storage medium according to claim 9, wherein the patient specific information includes food ingredients allergy information for the patient, the food ingredients allergy information comprising at least one selected from the group consisting of: a food ingredient allergic for the patient, a food ingredient non-allergic for the patient and a combination thereof, and wherein the one or more food ingredients to be replaced in the selected diet plan are identified based on the food ingredients allergy information for the patient.

12. The non-transitory computer-readable storage medium according to claim 9, wherein the patient specific information includes food desirability information for the patient, the food desirability information for the patient comprising at least one selected from the group consisting of: a food ingredient desirable by the patient, a food ingredient undesirable by the patient and a combination thereof, and wherein the one or more food ingredients to be replaced in the diet plan are identified based on the food desirability information for the patient.

13. The non-transitory computer-readable storage medium according to claim 9, wherein the patient specific information includes healthcare consultant recommendation for the patient, the healthcare consultant recommendation for the patient comprising at least one selected from the group consisting of: a food ingredient recommended for the patient by a healthcare consultant, a food ingredient rejected for the patient by the healthcare consultant and a combination thereof, and wherein the one or more food ingredients to be replaced in the selected diet plan are identified based on the healthcare consultant recommendation information for the patient.

14. The non-transitory computer-readable storage medium according to claim 9, wherein patient specific information includes the nutritional requirement of the patient.

15. The non-transitory computer-readable storage medium according to claim 9, wherein the patient specific information includes biographical information of the patient and wherein the nutritional requirement of the patient is determined based on the biographical information of the patient from a reference nutritional requirement database, wherein the reference nutritional requirement database includes a plurality of nutritional requirements for different persons classified according to at least one selected from the group consisting of: genders of the different persons, ages of the different persons, body weights of the different persons, diagnoses of the different persons, or a combination thereof.

16. The non-transitory computer-readable storage medium according to claim 9, wherein the patient specific information is received from a database of a healthcare provider.

17. A system for generating a preferred diet plan for a patient, the system comprising:
memory operable to store at least one program; and
at least one processing unit communicatively coupled to the memory, in which the at least one program, when executed by the at least one processing unit, causes the at least one processing unit to:
receive patient specific information including at least diagnoses information related to a diagnoses of the patient;
retrieve a set of standard diet plans from a plurality of standard diet plans stored in a diet plan database, wherein each standard diet plan corresponds to one or more diagnoses of a plurality of diagnoses;
select one of the standard diet plans from the set of standard diet plans based on a nutritional requirement of the patient, wherein the selected diet plan comprises a set of food ingredients;
identify, in the selected diet plan, one or more food ingredients to be replaced;
access an ingredient nutritional information database to select one or more alternate food ingredients;
select the one or more alternate food ingredients from the ingredient nutritional information database, wherein a nutritional value of the one or more alternate food ingredients corresponds to a nutritional value of the one or more food ingredients to be replaced from the selected diet plan; and
substitute, in the selected diet plan, the one or more alternate food ingredients for the one or more food ingredients to be replaced to generate the preferred diet plan for the patient.

18. The system according to claim 17 comprising a first data storage module, the first data storage module comprising at least a part of the diet plan database.

19. The system according to claim 17 comprising a second data storage module, the second data storage module comprising at least a part of the ingredient nutritional information database, the ingredient nutritional information database comprising a plurality of food ingredients wherein each food ingredient of the plurality is assigned a nutritional value including at least one selected from the group consisting of: a calorific value of the food ingredient, a protein content of the food ingredient, a carbohydrate content of the food ingredient, a fat content of the food ingredient, a mineral content of the food ingredient, a vitamin content of the food ingredient, a sugar content of the food ingredient, a salt content of the food ingredient, and a combination thereof.

20. The system according to claim 17 comprising a third data storage module, the third data storage module comprising at least a part of reference nutritional requirement database, the reference nutritional requirement database includes a plurality of nutritional requirements for different persons classified according to at least one selected from the group consisting of: genders of the different persons, ages of the different persons, body weights of the different persons, diagnoses of the different persons, or a combination thereof and wherein the patient specific information includes biographical information of the patient and wherein the nutritional requirement of the patient is determinable based on the biographical information of the patient from the reference nutritional requirement database.
